(19) United States
(12) Patent Application Publication
(10) Pub. No.: US 2018/0323636 A1
(43) Pub. Date: Nov. 8, 2018

(54) WIRELESS POWER CHARGING SYSTEMS AND ECOSYSTEM FOR SURFACE-BASED WIRELESS CHARGING SYSTEM

(71) Applicant: The Wiremold Company, West Hartford, CT (US)

(72) Inventors: Mark Makwinski, Cromwell, CT (US); Phillip D. Prestigomo, Simsbury, CT (US); Richard R. Picard, West Hartford, CT (US)

(21) Appl. No.: 16/031,392

(22) Filed: Jul. 10, 2018

Related U.S. Application Data
(63) Continuation-in-part of application No. 14/847,399, filed on Sep. 8, 2015, now Pat. No. 10,063,107.
Application No. 14/847,399 is a continuation-in-part of application No. 14/925,268, filed on Oct. 28, 2015.
Application No. 14/925,268 is a continuation-in-part of application No. 14/978,251, filed on Dec. 22, 2015.
(60) Provisional application No. 62/046,251, filed on Sep. 5, 2014.
(60) Provisional application No. 62/069,479, filed on Oct. 28, 2014.
(60) Provisional application No. 62/095,451, filed on Dec. 22, 2014.
(60) Provisional application No. 62/097,723, filed on Dec. 30, 2014.

(51) Int. Cl. H02J 7/02; H02J 7/00; H02J 50/40

(52) U.S. Cl. CPC H02J 7/025; H02J 7/0013; H02J 7/345; H02J 7/027; H02J 7/0042; H02J 50/40

(57) ABSTRACT

A portable charger tray includes an internal rechargeable power supply and a first wireless power transmitter connected to the internal rechargeable power supply for wirelessly charging a portable electronic device. A wireless power charging system includes the portable charger tray for wirelessly charging the portable electronic device and a dock for charging the internal rechargeable power supply of the portable charger tray.

### CROSS REFERENCE TO PRIOR APPLICATION

This application is a continuation-in-part of U.S. application Ser. No. 14/847,399, filed Sep. 8, 2015, which claims the benefit of U.S. Provisional Application No. 62/046,251 filed Sep. 5, 2014, each of which is hereby incorporated herein by reference in its entirety. This application is also a continuation-in-part of U.S. application Ser. No. 14/925,268, filed Oct. 28, 2015, which claims the benefit of U.S. Provisional Application No. 62/069,479 filed Oct. 28, 2014, each of which is hereby also incorporated herein by reference in its entirety. This application is also a continuation-in-part of U.S. application Ser. No. 14/978,251, filed Dec. 22, 2015, which claims the benefit of U.S. Provisional Application No. 62/095,451, filed Dec. 22, 2014, and the benefit of U.S. Provisional Application No. 62/097,723, filed Dec. 30, 2014 each of which applications is hereby also incorporated herein by reference in its entirety.

### TECHNICAL FIELD

The present disclosure relates to wireless power, and more particularly, to wireless charging systems.

### BACKGROUND

Portable electronic devices require periodic charging or recharging. It can be inconvenient, however, to utilize power cords and cables for charging portable electronic devices because, oftentimes, the power cords or cables for particular electronic devices are not interchangeable. Additionally, it can be inconvenient to make use of a portable electronic device while the device is plugged in for charging or recharging. In particular, plug connections and power cords or cables effectively tether the portable electronic devices to the outlets, thereby preventing portability of the electronic device and limiting the ability to use the portable device while it is being charged or recharged. Thus, the tether limits the range of locations at which the portable device can be used during charging.

Wireless power transmitters, such as the magnetic resonance units developed in accordance with the Rezence standard by the Alliance for Wireless Power, which is now know as the AirFuel Alliance, can transmit power to a suitably equipped receiving device through a non-metallic surface. Typically the transmitter is a standalone product with its own dedicated power supply which must be plugged into a receptacle connected to 120V branch circuit power (or the equivalent in other countries).

### SUMMARY

According to an aspect of the present disclosure, a portable charger tray includes an internal rechargeable power supply and a first wireless power transmitter connected to the internal rechargeable power supply for wirelessly recharging a portable electronic device. A wireless power charging system includes the portable charger tray for wirelessly recharging the portable electronic device and a dock for recharging the internal rechargeable power supply of the portable charger tray.

According to another aspect of the present disclosure, a wireless power charging station includes a bowl-shaped body with a bottom portion and a sidewall extending upwardly from the bottom portion. A wireless power transmitter is disposed within the bottom portion and connected to a power supply supplying power thereto. The wireless power transmitter is configured to transmit a wireless charging field upwardly from the bottom portion to a top of the sidewall.

According to another aspect of the present disclosure, a wireless charging system comprises a surface, a first power supply mounted underneath the surface, a first power distribution system mounted underneath the surface, and at least one wireless charging transmitter mounted underneath the surface, wherein the first power supply is connected to a first wireless charging transmitter of the at least one wireless charging transmitter through the first power distribution system, and wherein the first wireless charging transmitter is configured to create a first charging area on the top side of the surface.

According to the present disclosure, a wireless charging system includes a surface, a first power supply, a second power supply, a first power distribution system, a second power distribution system, a first wireless charging transmitter, a second wireless charging transmitter, a first occupancy sensor; and a second occupancy sensor, wherein the first power supply is connected to the first wireless charging transmitter through the first power distribution system, wherein the second power supply is connected to the second wireless charging transmitter through the second power distribution system, wherein the first occupancy sensor is configured to control whether the first power supply supplies power to the first wireless charging transmitter based on the detection of the presence and/or absence of a user in the vicinity of the first occupancy sensor, and wherein the second occupancy sensor is configured to control whether the second power supply supplies power to the second wireless charging transmitter based on the detection of the presence and/or absence of a user in the vicinity of the second occupancy sensor.

According to the present disclosure, a wireless charging system comprises a surface, a first power supply, a second power supply, a first power distribution system, a second power distribution system, a first wireless charging transmitter, a second wireless charging transmitter, at least one occupancy sensor, and a control interface, wherein the first power supply is connected to the first wireless charging transmitter through the first power distribution system, wherein the second power supply is connected to the second wireless charging transmitter through the second power distribution system, and wherein the control interface is configured to control whether the first power supply supplies power to the first wireless charging transmitter as well as whether the second power supply supplies power to the second wireless charging transmitter based on information received from the at least one occupancy sensor.

These and other objects, features and advantages of the present disclosure will become apparent in light of the following detailed description of non-limiting embodiments, with reference to the accompanying drawings.

### BRIEF DESCRIPTION OF DRAWINGS

The foregoing summary, as well as the following detailed description of the embodiments, is better understood when read in conjunction with the appended drawings. For the purpose of illustration, various embodiments are shown in the drawings, it being understood, however, that the present disclosure is not limited to the specific embodiments disclosed. In the drawings:

FIG. 1 shows an exemplary portable charger tray;

FIG. 2 shows a detailed partial cutaway view of an exemplary portable charger tray;

FIG. 3 shows an exemplary wireless power charging system;

FIG. 4 shows another view of the exemplary wireless power charging system of FIG. 3;

FIG. 5 shows a detailed partial cutaway view of an exemplary portable charger tray of the wireless power charging system of FIG. 3;

FIG. 6 shows another exemplary wireless power charging system;

FIG. 7 shows a top view of the interior of an exemplary portable charger tray of the power charging system of FIG. 6;

FIG. 8 shows a bottom view of the interior of the portable charger tray of FIG. 7;

FIG. 9 shows another exemplary wireless power charging system; and

FIG. 10 shows another view of the exemplary wireless power charging system of FIG. 9;

FIG. 11 shows a top view of the interior of an exemplary portable charger tray of the power charging system of FIG. 9;

FIG. 12 shows a bottom view of the interior of the portable charger tray of FIG. 11;

FIG. 13 is a side perspective view of an exemplary charging bowl;

FIG. 14 is a side cross-sectional view of an exemplary charging bowl;

FIG. 15 is a side perspective view of an exemplary charging bowl;

FIG. 16 is a schematic illustration of a plan view of an exemplary wireless charging system;

FIG. 17 is a schematic illustration of a plan view of an exemplary wireless charging system;

FIG. 18 is a schematic illustration of a plan view of an exemplary wireless charging system;

FIG. 19 is a schematic illustration of a plan view of an exemplary wireless charging system;

FIG. 20 is a schematic top view of an exemplary indication system for the wireless charging systems of FIGS. 16-19;

FIG. 21 is a schematic top view of an exemplary indication system for the wireless charging system;

FIG. 22 is a schematic top view of an exemplary indication system for the wireless charging systems of FIGS. 16-19;

FIG. 23 is a schematic top view of an exemplary indication system for the wireless charging systems of FIGS. 16-19; and

FIG. 24 is a schematic top view of an exemplary indication system for the wireless charging systems of FIGS. 16-19.

### DETAILED DESCRIPTION

Before the various embodiments are described in further detail, it is to be understood that the invention is not limited to the particular embodiments described. It is also to be understood that the terminology used is for the purpose of describing particular embodiments only, and is not intended to limit the scope of the claims of the present application.

In the drawings, like reference numerals refer to like features of the systems and devices of the present application. Accordingly, although certain descriptions may refer only to certain figures and reference numerals, it should be understood that such descriptions might be equally applicable to like reference numerals in other figures. Additionally, although various features have been shown in different figures for simplicity, it should be readily apparent to one of skill in the art that the various features may be combined without departing from the scope of the present disclosure.

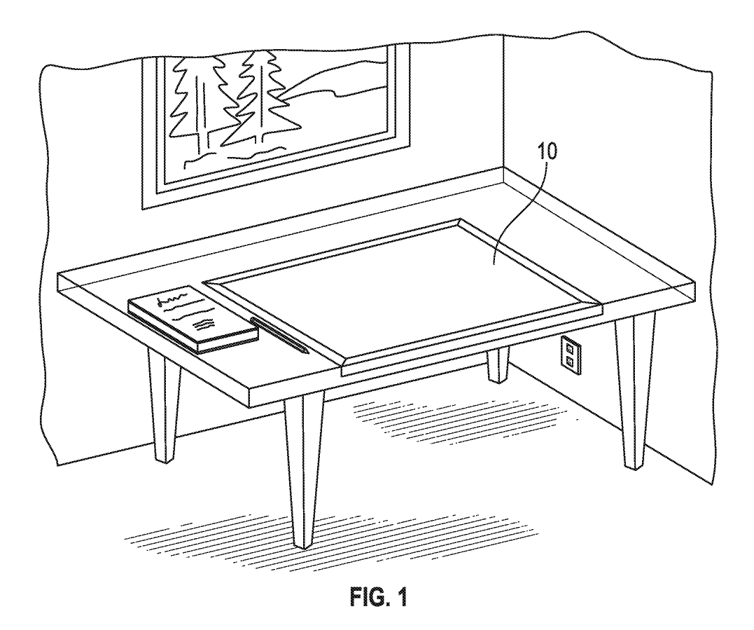

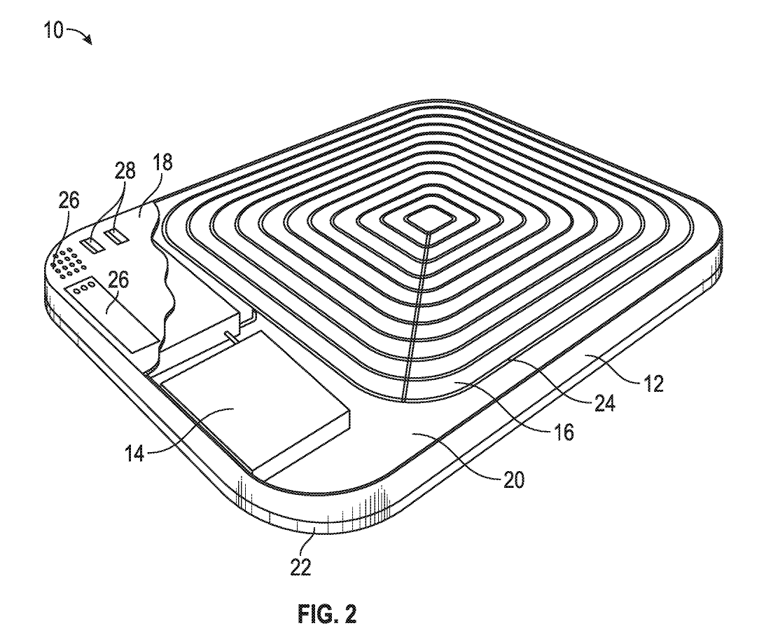

FIGS. 1 and 2 show a portable charger tray 10 adapted to wirelessly transmit charging power (i.e., current and voltage) to one or more electronic devices, such as e.g., mobile telephones, tablet computers, laptop computers, etc. In one embodiment, as shown in FIG. 2, portable charger tray 10 comprises a case 12 housing an internal rechargeable power supply 14 and a wireless power transmitter 16 connected to the internal rechargeable power supply 14. The Figures of the present application are schematic in nature. The various components may be shown in certain configurations and relative sizes, but it should be understood that the drawings are presented simply for illustrative purposes.

Case 12 of portable charger tray 10 defines a top supporting surface 18 adapted to support one or more electronic devices while charging. For example, top supporting surface 18 may be a planar surface covered with slip-resistant material. Also, case 12 of portable charger tray 10 may be completely sealed with waterproof or weather resistant materials, with no exposed electrical contacts or access to its internal battery, to facilitate outdoor use, make easier to clean and improve safety. Further, a bottom surface 20 of case 12 may include a cushion 22, which may be made of or filled with a soft material, such as a cushion foam, cushion gel, etc., so that portable charger tray 10 may be comfortably set on a person's lap. Case 12 of portable charger tray 10 may also incorporate at least one of a pad, a pen, a cup holder, speakers, a keyboard, or a remote control for a music player, lighting, or a television.

Internal rechargeable power supply 14 is connected to and supplies electrical power to wireless power transmitter 16. Power supply 14 may be any type of rechargeable power supply that can be adapted to provide electrical power to wireless power transmitter 16. For example, power supply 14 may be a battery, super capacitor, small fuel cell, etc. Further, power supply 14 may be a replaceable modular unit that is detachably connected to wireless power transmitter 16 and case 12 of portable charger tray 10. Accordingly, a spent power supply 14 may be easily replaced with a newly charged power supply 14. Additionally, power supply 14 may be designed in various capacities to accommodate various types of needs/uses.

Wireless power transmitter 16 is connected to and receives electrical from power supply 14. Further, wireless power transmitter 16 is configured to wirelessly transmit charging power to one or more electronic devices supported on or in close proximity to top supporting surface 18 of portable charger tray 10. Wireless power transmitter 16 may comprise a transmitting antenna 24 disposed inside case 12 in close proximity to top supporting surface 18. Wireless power transmitter 16 may implement any suitable wireless power standards/technologies for wirelessly transmitting charging power to one or more electronic devices. For example, wireless power transmitter 16 may implement Alliance for Wireless Power's Rezence branded solutions, Wireless Power Consortium's Qi branded inductive solutions, etc. In some embodiments, a shield may be disposed between the wireless power transmitter 16 and power supply 14 to prevent interference with the operation of wireless power transmitter 16.

Also, as shown in FIG. 2, in some embodiments, portable charger tray 10 may also include a status indicator 26 for visually indicating a charge level of internal rechargeable power supply 14, a charging status of internal rechargeable power supply 14 and/or a successful charging link to one or more electronic devices. Visual indicator 26 may include a plurality of discrete LEDs, and/or a display screen (e.g., an LED or LCD display). Status indicator 26 may also include a speaker for providing audible indications associated with a charge level of internal rechargeable power supply 14, a charging status of internal rechargeable power supply 14, a successful charging link to one or more electronic devices and/or impermissible use of portable charger tray 10 (i.e., use of portable charger tray 10 outside a permitted area). Further, as shown in FIG. 2, in some embodiments, portable charger tray 10 may also include one or more power jacks 28 operatively connected to internal rechargeable power supply 24 for supplying power to one or more electronic devices via a cable connection. For example, power jacks 28 may be USB compliant jacks.

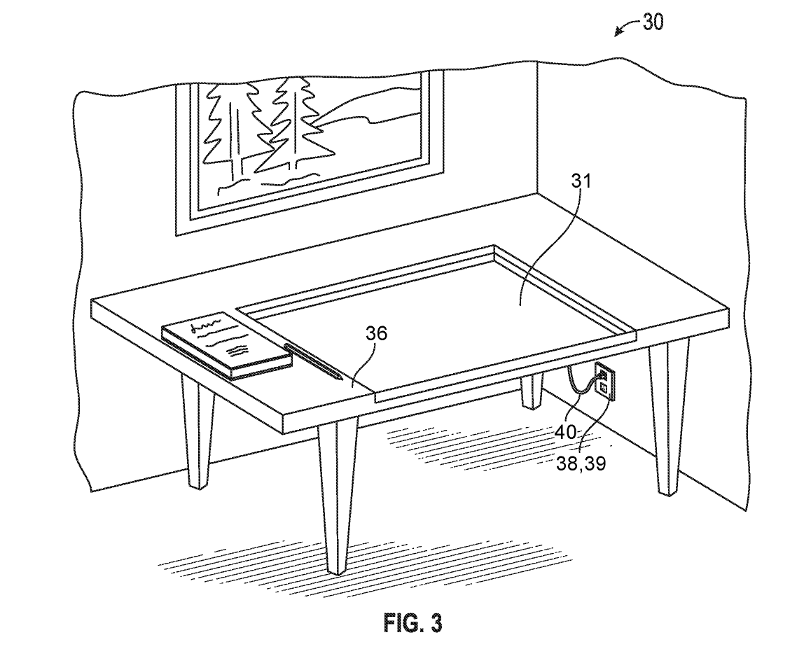

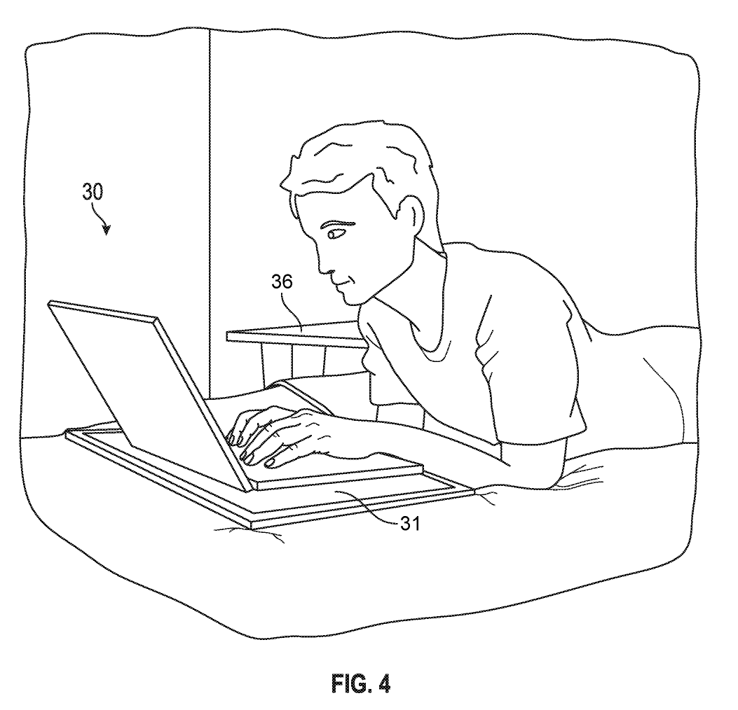

FIGS. 3 and 4 show a wireless power charging system 30 comprising a portable charger tray 31 and a recharging dock 36. Portable charger tray 31 includes all of the same components as portable charger tray 10 described above and additionally includes components for operatively coupling portable charger tray 31 to recharging dock 36. Accordingly, the above description of portable charger tray 10 is equally applicable to portable charger tray 31 and is incorporated by reference. Thus, the components of portable charger tray 31, which are in common with the components of portable charger tray 10, will herein be described by referring to the same names and reference numerals used to describe the components of portable charger tray 10 above.

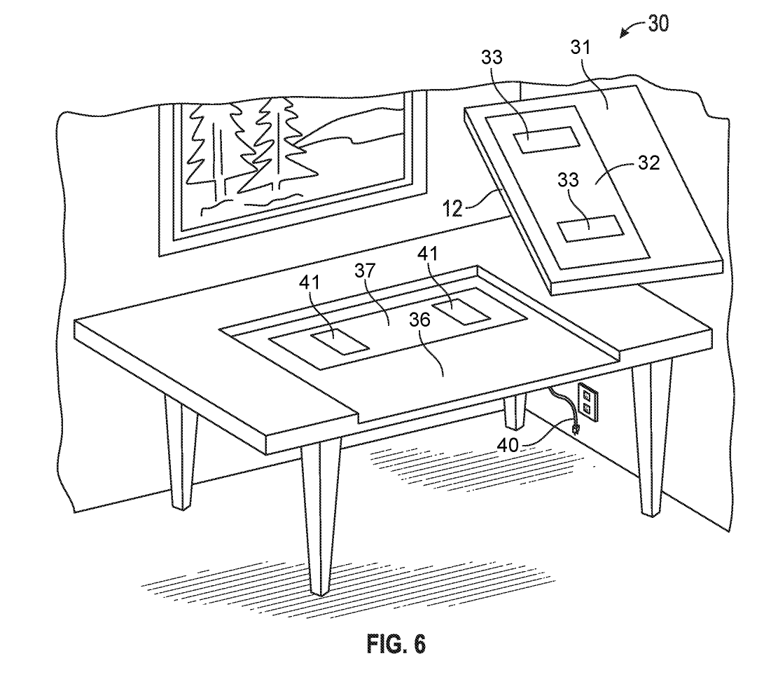

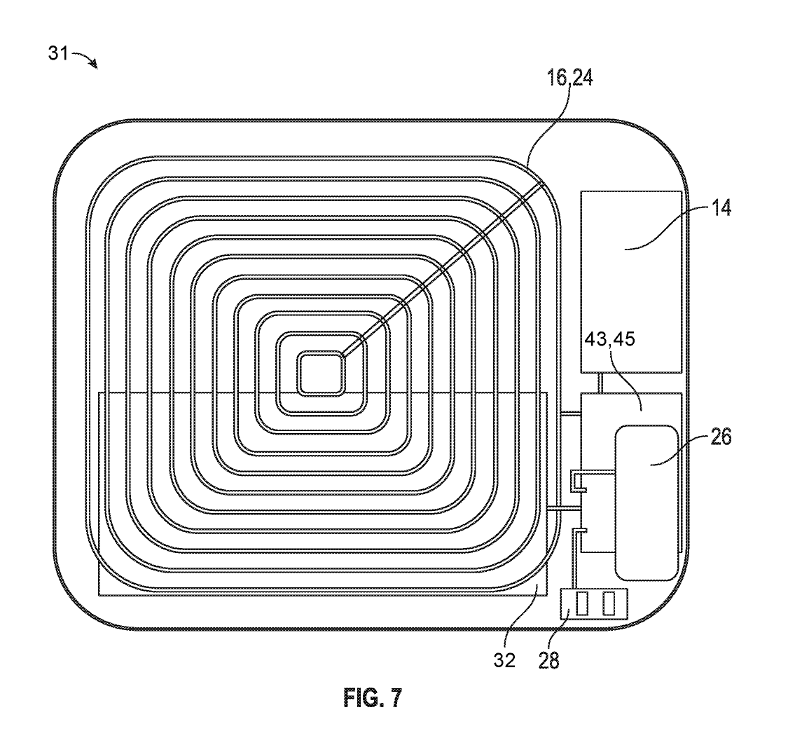

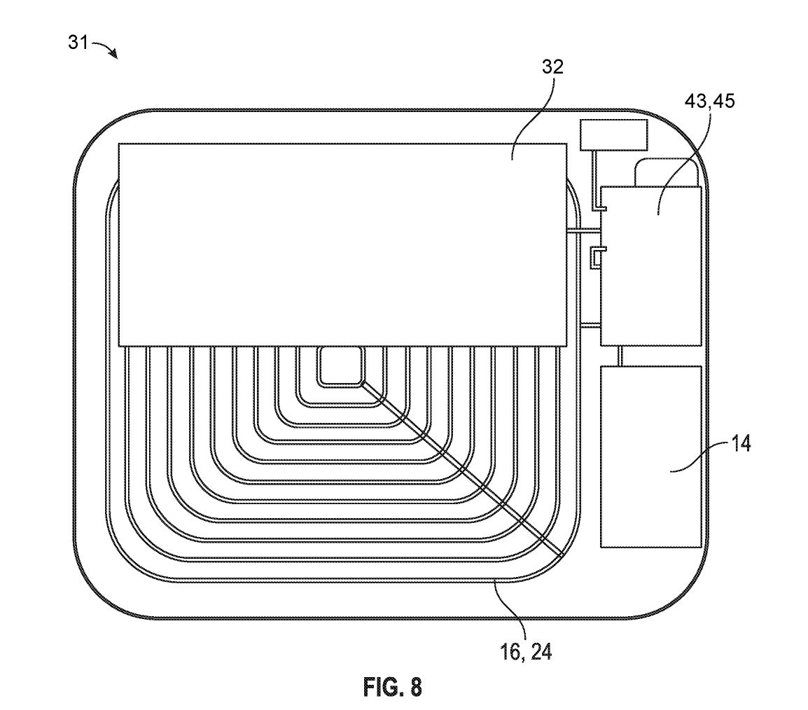

As shown in FIG. 3, portable charger tray 31 is operatively coupled to recharging dock 36 to recharge internal rechargeable power supply 14 of portable charger tray 31. As shown in FIGS. 6-10, in addition to the components described above in connection with portable charger tray 10, portable charger tray 31 includes a charging receiver 32 connected to internal rechargeable power supply 14. Charging receiver 32 supplies electrical power for charging internal rechargeable power supply 14 of portable charger tray 10. As shown in FIGS. 3, 6, 9 and 10, recharging dock 36 comprises a charging transmitter 37 configured to be connected to a power supply 38. Power supply 38 may be any type of power supply that can supply electrical power to charging transmitter 37. For example, as shown in FIG. 3, power supply 38 may be external to recharging dock 36, such as an in-wall electrical receptacle 39 connected to the primary alternating current (AC) power supply in a building. In such an embodiment as shown in FIG. 3, recharging dock 36 may comprise a conventional plug and cord 40, which may be connected to in-wall electrical receptacle 39 to provide 120 V AC to charging transmitter 37. Alternatively, power supply 38 may be a built-in power supply, such as a battery, super capacitor, small fuel cell, etc., which may be incorporated into recharging dock 36. Further, power supply 38 may be a replaceable modular unit that is detachably connected to charging transmitter 37 and recharging dock 36.

As shown in FIGS. 6, 9 and 10, charging receiver 32 of portable charger tray 31 and charging transmitter 37 of recharging dock 36 are adapted to be operatively connected to transmit charging power from recharging dock 36 to portable charger tray 31 for recharging internal rechargeable power supply 14 of portable charger tray 31. In one embodiment, as shown in FIGS. 6-8, conductive contacts 33 of charging receiver 32 of portable charger tray 31 are adapted to contact or mate with conductive contacts 41 of charging transmitter 37 of recharging dock 36 to transmit charging power from recharging dock 36 to portable charger tray 31. Alternatively, charging receiver 32 of portable charger tray 31 may comprise one of an electrical plug or socket connector and charging transmitter 37 of recharging dock 36 may comprise the other of a mating electrical plug or socket connector, which may be mated to transmit charging power from recharging dock 36 to portable charger tray 31.

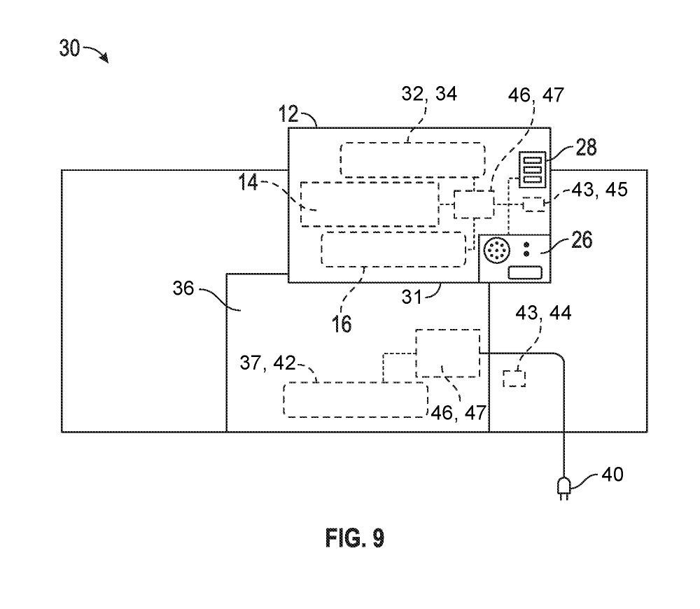

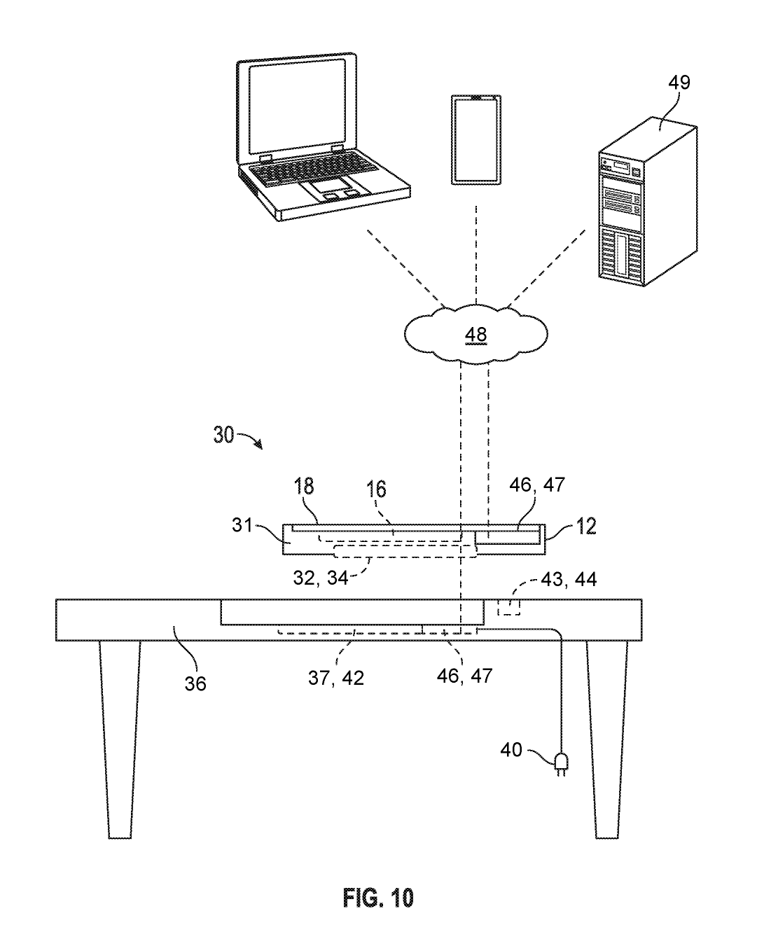

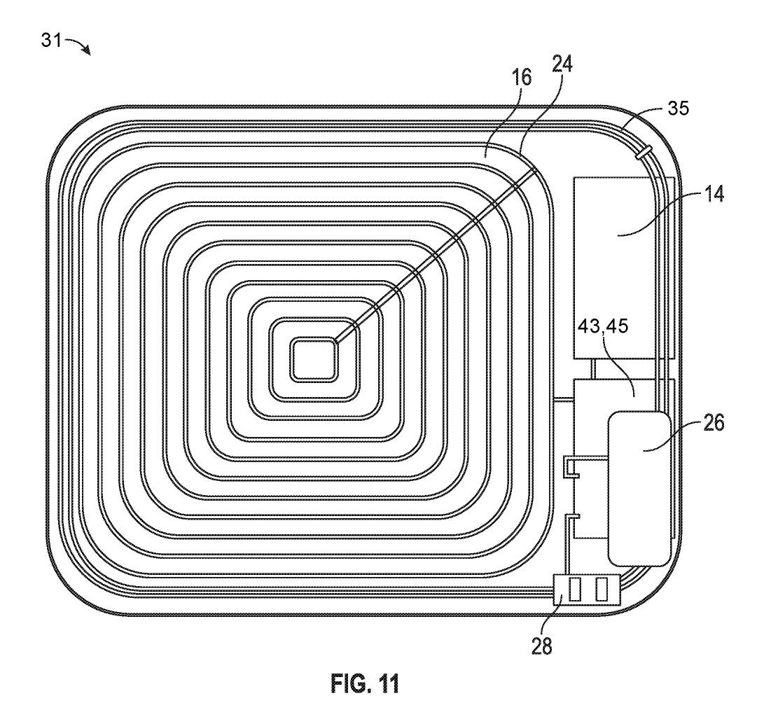

In another embodiment, as shown in FIGS. 9-12, charging receiver 32 of portable charger tray 31 and charging transmitter 37 of recharging dock 36 may be operatively connected to wirelessly transmit charging power from recharging dock 36 to portable charger tray 31 for recharging internal rechargeable power supply 14 of portable charger tray 31. In such an embodiment as shown in FIGS. 9-10, charging receiver 32 of portable charger tray 31 includes a wireless power receiver 34 and charging transmitter 37 of recharging dock 36 includes a wireless power transmitter 42, which are adapted to wirelessly transmit charging power from recharging dock 36 to portable charger tray 31 for recharging internal rechargeable power supply 14 of portable charger tray 31. In some embodiments, a shield may be disposed between wireless power receiver 34 and power supply 14 to prevent interference with the operation of wireless power receiver 34. Wireless power transmitter 42 and wireless power receiver 34 may implement any suitable wireless power standards/technologies for wirelessly transmitting charging power from recharging dock 36 to portable charger tray 31. For example, wireless power transmitter 42 may implement Alliance for Wireless Power's Rezence branded solutions, Wireless Power Consortium's Qi branded inductive solutions, etc.

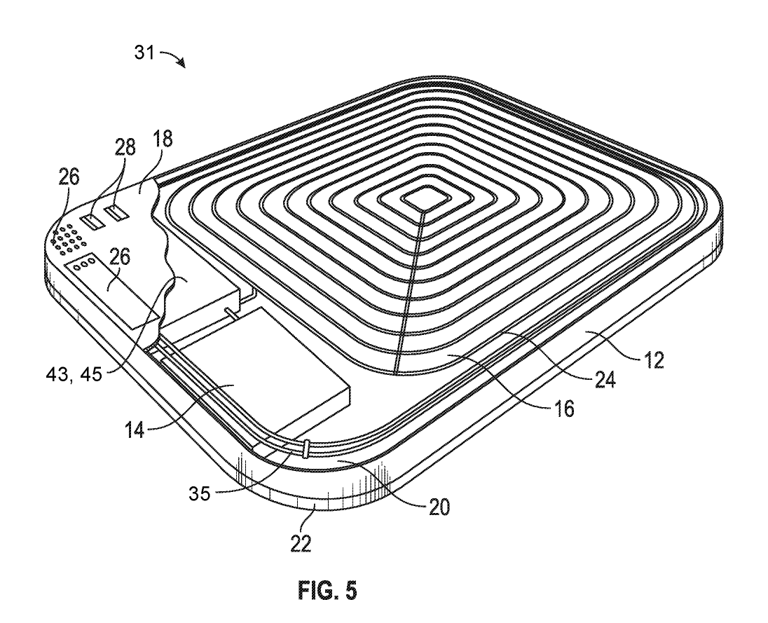

In some embodiments, as shown in FIGS. 5 and 11-12, portable charger tray 31 may further include a coil 35 housed in case 12, which acts as a passive resonant repeater to transfer power from a transmitting antenna of wireless power transmitter 42 of recharging dock 36 to a receiving antenna of one or more electronic devices. Accordingly, when portable charger tray 31 is operatively coupled to recharging dock 36, charging receiver 32 and wireless power transmitter 16 of portable charger tray 31 act as a passive resonant repeater to transfer power from a transmitting antenna of wireless power transmitter 42 of recharging dock 36 to a receiving antenna of one or more electronic devices, while also charging internal rechargeable power supply 14. Thereby, coil 35 allows portable charger tray 31 to simultaneously charge its own internal rechargeable power supply 14 and also charge one or more electronic devices supported on or in close proximity to top supporting surface 18 of portable charger tray 31.

Additionally, in some embodiments, as shown in FIGS. 5 and 7-12, wireless portable charger system 30 may further comprise control means 43 for determining whether portable charger tray 31 is within a designated operational distance from recharging dock 36. Further, control means 43 may be configured to disable portable charger tray 31 when portable charger tray 31 is beyond a designated operational distance from recharging dock 36. In one embodiment, control means 43 may comprise a first controller 44 associated with recharging dock 36 in communication with a second controller 45 housed in case 12 of portable charger tray 31. First controller 44 and second controller 45 can be, for example, microprocessors. Either first controller 44 associated with recharging dock 36 or second controller 45 in portable charger tray 31 can be configured to determine a distance between portable charger tray 31 and recharging dock 36, such as by receiving and processing signals from appropriate sensors, which may be integrated into or separate from the controller. Additionally, one of the controllers 44, 45 can be configured to determine whether portable charger tray 31 is beyond a designated operational distance from recharging dock 36. Further, controller 45 in portable charger tray 31 may be connected to wireless power transmitter 16 of portable charger tray 31, and may be configured to disable wireless power transmitter 16 when portable charger tray 31 beyond a designated operational distance from recharging dock 36. Thus, controller 45 may prevent charging of electronic devices by portable charger tray 31 if portable charger tray 31 is outside a permissible use area. Additionally, controller 45 may be connected to status indicator 26 of portable charger tray 31 for indicating whether portable charger tray 31 is within or beyond a designated operational distance from recharging dock 36.

Furthermore, in some embodiments, as shown in FIGS. 9-10, wireless portable charger system 30 may further comprise a communication module 46 in communication with a system network 48. Communication module 46 may be implemented on one or more microprocessors 47 and may communicate with system network 48 via any suitable communication protocol, including but not limited to: Ethernet, Wi-Fi, BLUETOOTH®, GSM and TCP/IP. Communication module 46 may be associated with portable charger tray 10, 31 and/or recharging dock 36 and adapted to communicate to system network 48 the status of recharging dock 36 and/or portable charger tray 10, 31, including but not limited to information processed by status indicator 26 (e.g., charge level of power supply 14 and 38, charging status of power supply 14 and 38, malfunction of portable charger tray 10, 31 or recharging dock 36, whether portable charger tray 31 is within a designated operational distance from recharging dock 36).

Additionally, as shown in FIG. 10, communication module 46 may also be adapted communicate with electronic devices via a software application executing on the electronic devices. Accordingly, communication module 46 may communicate information between electronic devices and system network 48. For example, communication module 46 may communicate between electronic devices and system network 48 information such as, for example, device/user authentication information for use of charging service, payment information for use of charging service, location information of device/user, promotional information regarding products/services (e.g., hotel promotions).

As shown in FIG. 10, system network 48 may include a central management server 49 for receiving and processing information received from a plurality of portable charger trays 10, 31, recharging docks 36 and electronic devices. Central management server 49 allows for central monitoring of the status of a plurality of portable charger trays 10, 31 and recharging docks 36, which is advantageous in the context of a large deployment of portable charger trays 10, 31 and recharging docks 36, such as in a hotel setting.

As shown in the Figures, portable charger tray 31 and recharging dock 36 are configured to be operatively connected to transmit charging power from recharging dock 36 to portable charger tray 31. To that end, portable charger tray 31 and recharging dock 36 may be sized and shaped to complement each other and facilitate their operative connection. In one embodiment, recharging dock 36 may be a portable device. In another embodiment, recharging dock 36 may be incorporated into a work surface, such as, for example, a desk, a table, a nightstand, a bureau, a bookshelf, etc. Alternatively, Recharging dock 36 may be incorporated into a structural feature of a room, such as, for example, a wall, built-in shelf, etc. Recharging dock 36 may comprise a receptacle for receiving portable charger tray 31, so that portable charger tray 31 may be securely nested in recharging dock 36. In one embodiment, portable charger tray 31 may have the shape of a flat tray configured to fit in a receptacle of recharging dock 36 so that top supporting surface 18 of portable charger tray 31 is flush with a work surface of recharging dock 36. This permits use of portable charger tray 31 as part of a work surface of recharging dock 36. Portable charger tray 31 may be sized and shaped to accommodate various uses. For example, portable charger tray 31 may be sized to accommodate a single electronic device or multiple electronic devices for charging simultaneously.

Additionally, each of portable charger tray 31 and recharging dock 36 may include complementary surfaces for facilitating their operative connection. For instance, the complementary surfaces of portable charger tray 31 and recharging dock 36 may include conductive contacts 33 and 41, or wireless power receiver 34 and wireless power transmitter 42, respectively, so that they can be coupled to transmit charging power from recharging dock 36 to portable charger tray 31. Preferably, the complementary surfaces of portable charger tray 31 and recharging dock 36 are standardized so that any of a plurality of portable charger trays 31 can be used in conjunction with any of a plurality of recharging docks 36.

In use, as shown in FIGS. 3-4, portable charger tray 31 can be detached from recharging dock 36 and can be used to recharge or otherwise sustain operation of one or more portable electronic devices remotely from recharging dock 36 but still within a designated operational distance from recharging dock 36. In the event that portable charger tray 31 requires recharge of its internal rechargeable power supply 14, portable charger tray 31 may be returned to and operatively connected to recharging dock 36—as shown in FIG. 3—to recharge internal rechargeable power supply 14. Alternatively, in the event that portable charger trays 10, 31 require recharge of its internal rechargeable power supplies 14, the spent power supplies 14 may be replaced with charged power supplies 14. Such a use would allow for power supplies 14 to be charged at one central location or a few locations and to then be distributed for use.

As is evident from the above description of various embodiments, portable charger tray 31 and recharging dock 36 may be optimized for the users' convenience in the context of the setting in which portable charger trays 10, 31 and recharging dock 36 are to be used. While implementation of portable charger trays 10, 31 and recharging dock 36 may have been described in the context of a hotel setting, it should be recognized that portable charger trays 10, 31 and recharging dock 36 may be easily adapted for use in other settings, such as, for example, homes, dormitories, public lounges/bar/restaurants, waiting areas, offices, etc.

Although portable charger tray 10 has been described as being used to charge the power supplies (e.g., rechargeable batteries) of electronic devices (e.g., mobile telephones, tablet computers, laptop computers), it should be understood that portable charger tray 10 may also be used to directly power electronic devices using the same wireless power transmission generated by wireless power transmitter 16.

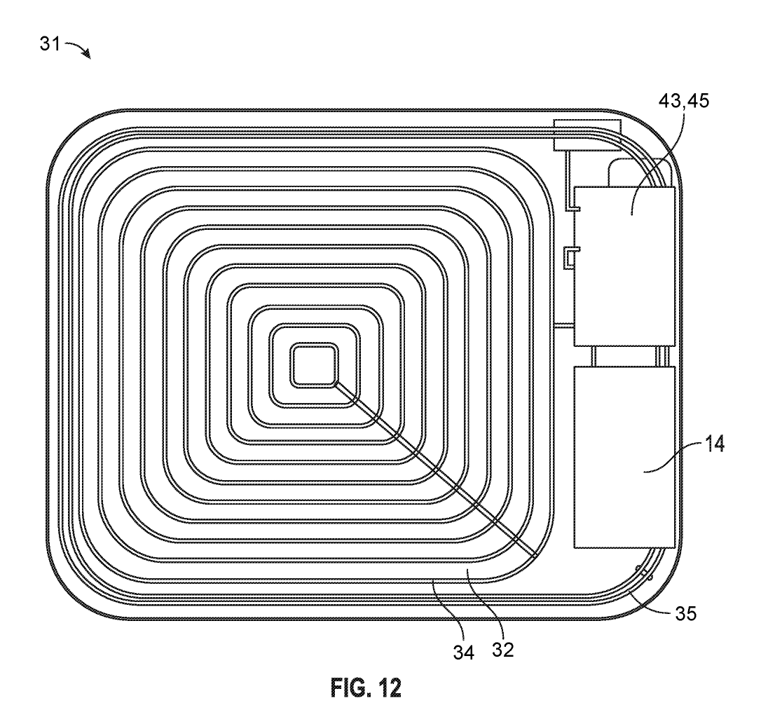

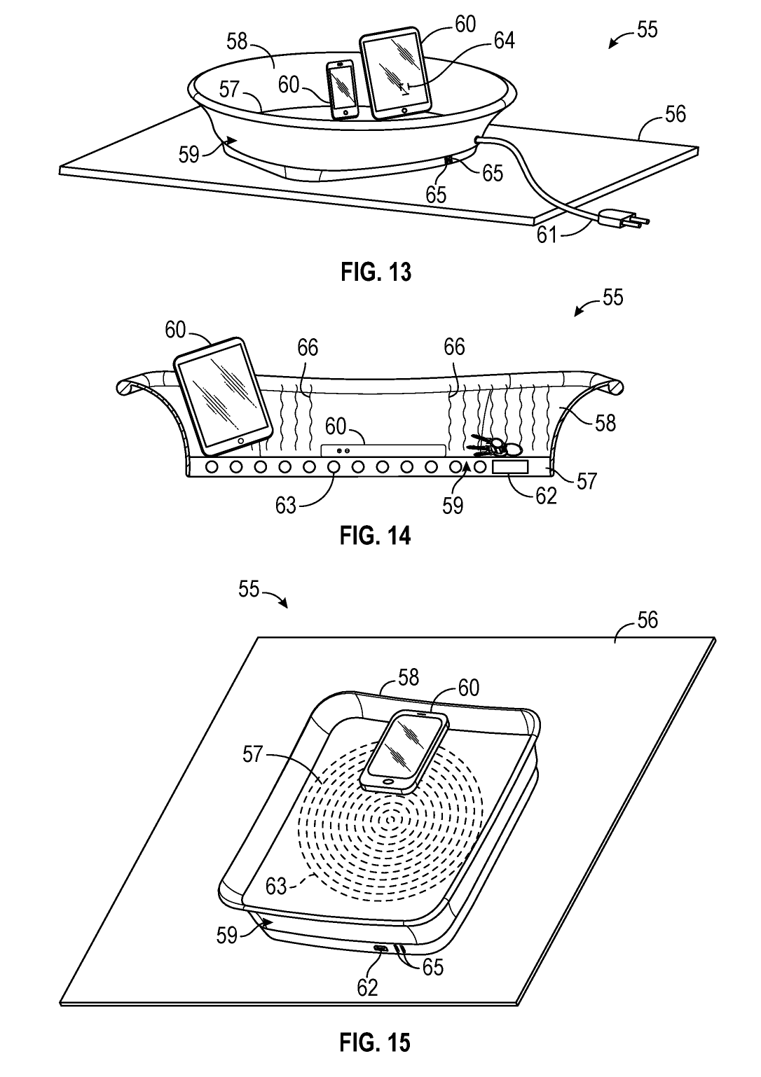

Referring to FIGS. 13 and 14, a charging tray or bowl 55 for use on a table or surface 56 includes a bottom portion 57 and sidewalls 58 extending from the bottom portion. The sidewalls 58 may have a circular shape, ovular shape, square or rectangular shape, inverted frusto-conical shape, inverted frusto-pyrimidal shape, as seen in FIG. 15, or any other sidewall shape that, together with the bottom portion 57, provides the charging bowl 55 with a bowl-like shape. The bowl 55 also includes a wireless portion 59 for wirelessly transmitting charging power (i.e., current and voltage) to wirelessly charge electronic devices 60, such as for example, mobile phones, tablets, laptops or the like. The charging bowl 55 may also include a power cord 61 for providing power thereto, as shown in FIG. 13. Alternatively or in addition thereto, the bowl 55 may include a battery power portion 62, as shown in FIG. 14, such as a rechargeable power supply, a replaceable battery or the like.

The wireless portion 59, including a magnetic resonant wireless power transmitter or coil 63, provides power to compatible receivers 64 disposed in devices 60 placed on/into the charging bowl 55. The wireless portion 59 may implement any suitable wireless power standards/technologies for wirelessly transmitting charging power to one or more electronic devices 60.

The charging bowl 55 may also include one or more USB ports 65 operatively connected to the power cord 61 or battery power portion 62 for supplying power to one or more electronic devices 60 via a cable or corded connection. The one or more USB ports 65, thus, allow electronic devices 60, that may or may not included compatible receivers 64 for wireless charging, to be plugged in and charged by the charging bowl 55 through a cable or corded connection.

The transmitter or coil 63 is substantially planar and is accommodated within the bottom portion 57 of the bowl 55. For example, the transmitter or coil 63 may be a Titan 16 Watt Power Transmitting Unit manufactured by Gill Electronics or any other similar transmitter or coil. The transmitter or coil 63 is connected to and receives power from the power cord 61 and/or the battery power portion 62. The transmitter or coil 63 is tuned to transmit a charging field 66 having a height that extends to at least the top of the sidewalls 58 of the charging bowl 55 by throwing the charging field 66 outward. The sidewalls 58 of the bowl are sufficiently shallow to allow receivers 64 of devices 60 to be within the range of the transmitter 63 to charge devices 60 placed within the bowl 55. For example, the sidewalls may extend to a height in the range of twenty-five (25) millimeters to forty-five (45) millimeters or the sidewalls may extend to a height smaller than twenty-five (25) millimeters, such as five (5) millimeters. Devices 60 may be placed either in a flat position or at an angle in the bowl and still be wirelessly charged therein. Angled positioning of the devices within the bowl advantageously allows for the bowl 55 to accommodate more devices therein.

The charging bowl 55 allows convenient wireless charging of various devices 60 while keeping various devices neatly in one place and without requiring separate power cords or cables for each device. Additionally, other items, such as for example, keys and coins can also be placed in the bowl 55 upon entering the house and will not interfere with the charging function of the bowl 55. Additionally, the charging bowl 55 can be conveniently moved and placed in any location.

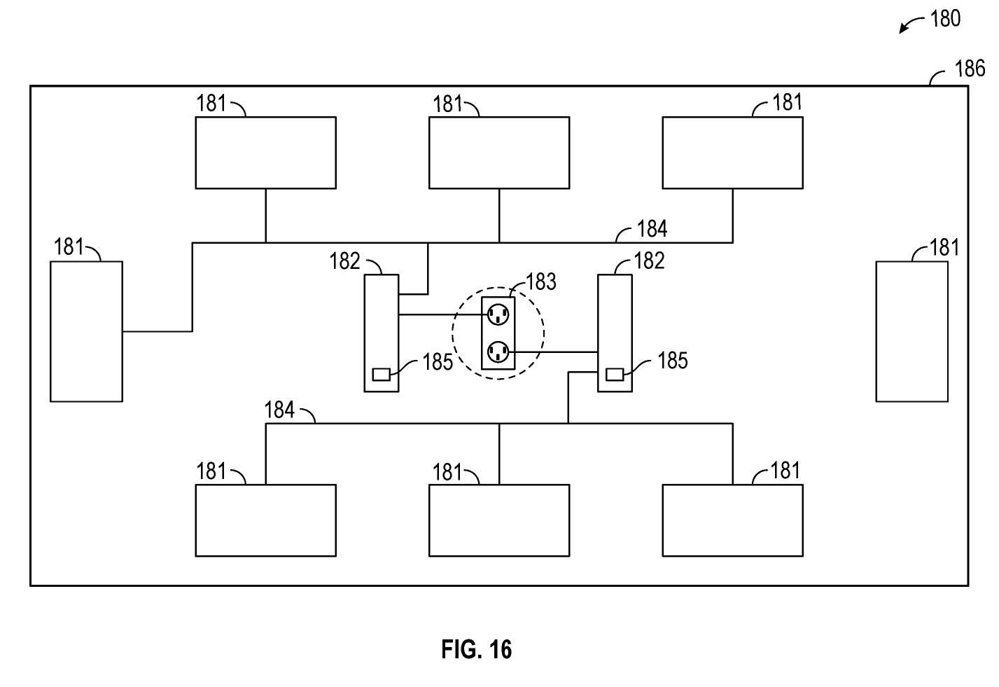

FIG. 16 shows a wireless charging system 180 according to an embodiment of the present disclosure. The wireless charging system 180 is mounted to the underside of a large surface. In FIG. 16, the large surface is in the form of a conference-room table 186. It should be understood, however, that the wireless charging system 180 can be mounted to any other surface in accordance with the principles of the present disclosure including without limitation a desk, a bar, a countertop, or a community table in a lobby, coffee shop, waiting room, library, airport lounge, or gate area. The wireless charging system 180 includes multiple wireless charging transmitters 181, at least one power supply 182 and a power distribution system 184 connecting each wireless charging transmitter 181 to a power supply 182 of the at least one power supply 182. The wireless charging transmitters 181 may be in the form of rectangular-shaped mats that are mounted to the underside of the table 186, as seen in FIG. 16, and are configured to emit charging fields upward through the table 186 to charge devices on the top surface of the table 186. It should be understood that the form of the wireless charging transmitter 181 is not limited to being rectangular shaped and may take on various other shapes in accordance with the principles of the present disclosure including without limitation circular mats, elliptical mats, square mats or any other suitably shaped mats. In FIG. 16, eight transmitters 181 are shown, although it should be understood that any number of transmitters can be used in accordance with the principles disclosed in the present disclosure. The wireless charging transmitters 181 may be mounted to portions of the table 186 adjacent to the locations where individuals will sit so that the individuals can easily orient their devices requiring charging on charging areas located on the top surface of the table above the wireless charging transmitters 181. Thus, the wireless charging transmitters 181 can wirelessly provide power to charge suitably configured devices that are put on the top of the surface in the vicinity of the transmitters 181. Such devices can include, for example, smart phones, tablets, and laptop computers.

The at least one power supply 182 of the wireless charging system 180 provides power to one or more of the wireless charging transmitters 181. In FIG. 16, two power supplies 182 are shown, each power supply 182 providing power to four of the eight wireless charging transmitters 181. The power supply may have an ordinary corded plug at one end that can be plugged into an ordinary electrical receptacle 183 that supplies AC power. Alternatively, the power supply may be hardwired to a source of AC power. The receptacle may be, for example, part of an in-floor poke-through device that is located beneath the table 186. If the power supply is plugged into an ordinary AC electrical outlet 183 or hardwired to a source of AC power, then it may contain an AC/DC converter so that the output of the power supply will be DC (direct current) power as should be understood by those skilled in the art. Each power supply 182 can be mounted directly to the underside of the conference table 186 at a location that is closer to the center of the table 186 than the locations of the wireless charging transmitters 181, which may be located more towards the periphery of the table 186 so that they establish charging areas that are near the periphery of the table 186 and are, therefore, easily accessible by those seeking to charge their devices. Each power supply 182 may be secured to the underside of the table 186 via brackets or mounts, or in a special purpose enclosure. Alternatively, each power supply 182 can be integrated into the table or can be integrated within other products that support power delivery to the table, such as floorboxes, power columns, transition channels, and the like as should be understood by those skilled in the art.

As discussed above, the wireless charging system 180 also includes a power distribution system 184 for connecting the output of the at least one power supply 182 to each one of the wireless charging transmitters 181 that is connected to the power supply 182. In FIG. 16, a power distribution system 184 is shown for each of the two power supplies 182. The power distribution system 184 can take many different forms. For example, the power distribution system 184 may be a separate cable for each connected wireless charging transmitter 181 running to the power supply 182. The cables can be stand-alone cables with dedicated cable management or they can be routed through a common conduit for cable-management purposes. Alternatively, the power distribution system 184 can be in the form of a solid bus bar with extensions from the bus bar to each connected wireless charging transmitter 181. Additionally, instead of rigid extensions from the bus bar to each connected transmitter 181, flexible cables that tap into the bus bar may be used. In FIG. 16, the power distribution systems 184 are shown as solid bus bars for ease of illustration.

Each power supply 182 may include a single on-off switch 185. Alternatively each power supply 182 may include a separate on-off switch for each one of the wireless charging transmitters 181 connected thereto. If the power supply 182 contains a single on-off switch 185, the switch can be physically located upstream of the main components of the power supply 182 itself so that when the switch is off even those components cannot draw power. For example, a typical AC/DC converter draws some power even when no loads are connected to its output and, therefore, locating the switch 185 upstream of such components will prevent them from drawing power when the power supply 182 is switched off.

The capacity of the at least one power supply 182 may be selected according to the power ratings of the individual wireless charging transmitters 181 connected to the at least one power supply 182. For example, a 120 W power supply 182 may be connected to four 30 W wireless charging transmitters 181. Additionally, a fifth or more wireless charging transmitter 181 may be connected to the same at least one power supply 182 to increase the effective charging area of the wireless charging system 180, since in practice, all four wireless charging transmitters may never draw 30 W at the same time, because, in reality, users may not simultaneously charge devices on all four wireless charging transmitters 181. The system 180 of the present disclosure is adaptable in this way.

The wireless charging system 180 has several advantages over a system in which each wireless charging transmitter has its own power supply. For example, by using shared power supplies 182 there are less power cords that must be plugged in to a receptacle, thereby reducing the clutter associated with a number of cords and reducing the total number of receptacles required. This is especially advantageous when the receptacles are located below the surface to which the wireless charging transmitters 181 are mounted such as either in the floor or directly on the floor. For example, the receptacles 183 may be located in one or more poke-through devices or floor-boxes located in the floor below a conference room table 186. Alternatively, the receptacles 183 may be located just above the surface of the floor in, for example, a floor-mounted box. By reducing the number of cords extending to such receptacles 183, the wireless charging system 180 advantageously reduces potential tripping hazards. Another advantage is that a shared powered supply 182 can be mounted at a more central location of the conference table 186 than the wireless charging transmitters 181, which makes them less likely to be a nuisance to people sitting at the table 186. Advantageously, shared power supplies 182 also allow a set of connected wireless charging transmitters 181 to be powered on and off together, through a single switch 185 on the power supply 182. Using a shared power supply 182 can also advantageously reduce the total wattage required for the system 180. For example, when each wireless charging transmitter has its own power supply, that power supply must be able to supply the minimum number of watts required to charge a device that the wireless charging transmitter is rated to charge. With a shared power supply 182, however, the total watts for the power supply 182 need not be the sum of the required watts for the connected wireless charging transmitters 181. Instead, as discussed above, the fact that it is not likely that all of the connected wireless charging transmitters 181 will be loaded with a device to be charged at the same time may allow the power supply 182 to generate a total power that is less than what would be necessary to power all of the connected transmitters 181 as if they were loaded at the same time.

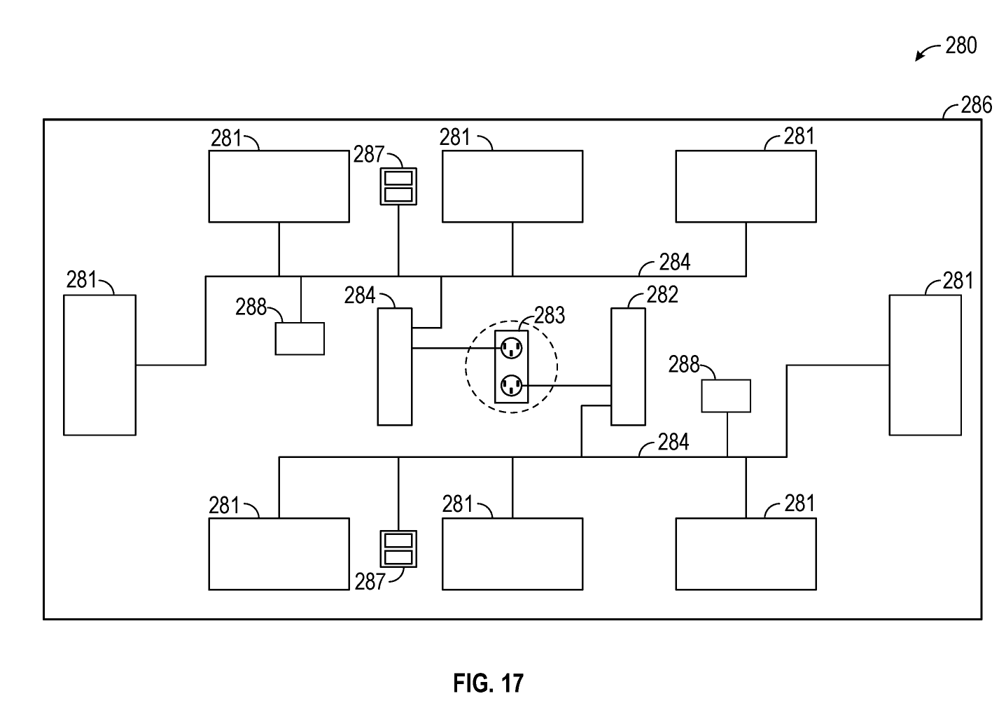

FIG. 17 shows a wireless charging system 280 that, like the embodiment in FIG. 16, includes wireless charging transmitters 281 that are electrically connected to shared power supplies 282 through electrical distribution systems 284. Wired charging points 287 are also connected to the power supplies 282 in addition to the wireless charging transmitters 281. The wired charging points 287 may be, for example, in the form of USB sockets. The exemplary embodiment of FIG. 17 shows two wired charging points 287 that each have two USB sockets. However, as should be understood by those skilled in the art, different numbers of wireless charging points 287 may be provided having different numbers of USB sockets. The wired charging points 287 may be integrated with the table 286 such that they are flush with the surface of the table 286 or they may be mounted to the top surface or to the underside of the table 286. The wired charging points 287 advantageously permit charging of devices that are not designed to interact and be charged by wireless charging transmitters 281. Since the wireless charging points 287 are connected to the shared power supplies 282 through the electrical distribution system 284, the wired charging points 287 do not require their own power supply and attendant power cord, which would create clutter underneath the table 286 and occupy the limited number of floor receptacles 283 as discussed above. Instead, they are simply electrically connected to the shared power supplies 282. As should be understood by those skilled in the art, a step-down power regulator may be required to connect the wireless charging points 287 to the shared power supplies 282.

In embodiments, the wireless charging system 280 may be configured with USB3.1 so that wired charging points 287, in the form USB sockets, may also be connected to a USB hub 288, for example, through the electrical distribution system 284 to allow data transmission and/or exchange between the wired charging points 287 and the USB hub 288. These USB3.1 wired charging points 287 may allow a device connected to one of the wired charging points 287 to send data and/or digital video back to the USB hub 288, which may, in turn, be connected to a display or projector, thereby allowing the device to display video output on the display or projector while being charged and/or powered by the wired charging points 287. Wired charging points 287 may include USB Type-C Connectors and may comply with the USB PD (Power Delivery) specification. When a wired charging point 287 is compliant with the USB PD specification, power for one or more of the transmitters 281 can be supplied through a cable connected to the wired charging point instead of through a shared power supply 282.

Additionally, since USB3.1 may provide higher currents and supply voltages, the wired charging points 287 that are USB3.1 connections may advantageously power devices with larger energy demands, such as laptops, and/or may also provide power to the wireless charging transmitters 281 over this USB connection.

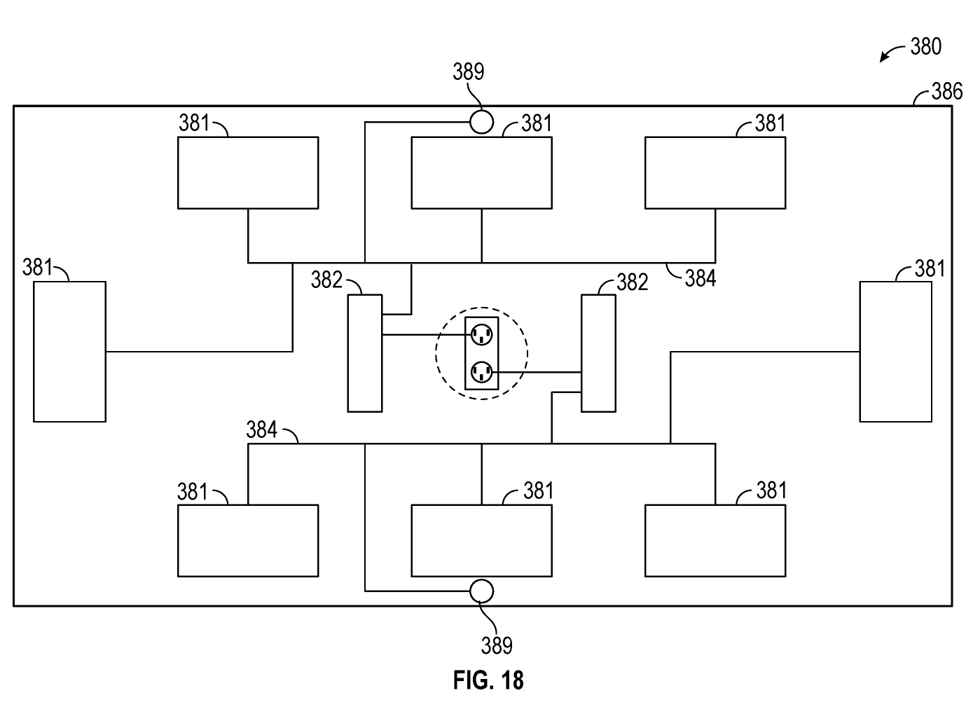

FIG. 18 shows a wireless charging system 380 that, like the embodiment in FIG. 16, includes wireless charging transmitters 381 that are electrically connected to shared power supplies 382 through electrical distribution systems 384. The wireless charging system 380 also includes at least one occupancy sensor 389 that senses the presence or absence of a person in the vicinity of sensor. The exemplary embodiment of FIG. 18 shows a wireless charging system with two occupancy sensors 389. However, as should be understood by those skilled in the art, fewer or more occupancy sensors 389 may be provided as desired or necessary. The occupancy sensors 389 may use any of a variety of technologies to sense the presence of a person including, without limitation, passive infrared energy, ultrasound energy, or video imaging. The occupancy sensors 389 can be physically mounted to the underside and/or the top of the conference table 386. The occupancy sensors 389 may also be mounted to the ceiling or wall of the room or any other suitable location for detecting the presence or absence of persons. The occupancy sensors 389 can be used as a switch to control whether the wireless charging transmitters 381 are powered on or off. For example, as shown in FIG. 18, the occupancy sensors 389 can be electrically connected to the power supplies 382 through the electrical distribution system 384 and can send occupancy signals to the power supplies 382 through such electrical connection. The occupancy signals can be used to control whether the power supplies 382 provide power to the wireless charging transmitters 381 by, for example, controlling a switch within each power supply 382. System logic in the power supplies 382 could be set to only turn off power to the transmitters 381 if the sensors 389 detect that nobody is present and no device is currently being charged.

As shown in FIG. 18, the occupancy sensor 389 on one side of the table 386 may be electrically connected to the shared power supply 382 for the wireless charging transmitters 381 on that side of the table 386 and the occupancy sensor 389 on the other side of the table 386 can be electrically connected to the shared power supply 382 for the wireless charging transmitters 381 on the other side of the table 386. In this configuration, the detection of the presence of a person on one side of the table 386 will power the wireless charging transmitters 381 on that side of the table 386 but, advantageously, will not power the wireless charging transmitters 381 on the other side of the table 386. This construction prevents unnecessary powering of all of the wireless charging transmitters 381 as the person is unlikely to reach over to the other side of the table 386 to charge a device when there are charging areas on the person's side of the table 386.

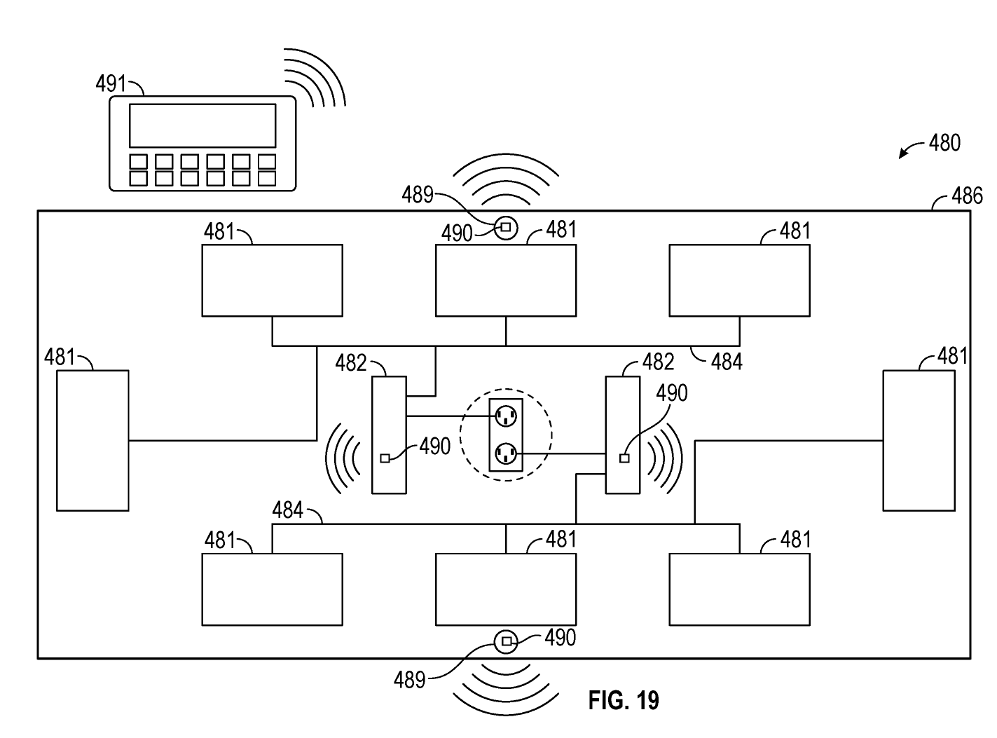

FIG. 19 shows a wireless charging system 480 that, like the embodiment in FIG. 18, includes wireless charging transmitters 481 that are electrically connected to shared power supplies 482 through electrical distribution systems 484. The wireless charging system 480 also includes at least one occupancy sensor 489 that senses the presence or absence of a person in the vicinity of sensor. In the wireless charging system 480, the two exemplary occupancy sensors 489 and the power supplies 482 include wireless transceivers 490 that allow them to communicate with a wireless network. A control interface 491 is also connected to the network and able to communicate with the power supplies 482 and sensors 489. The control interface 491 can be a stand-alone hardware device or it could be a laptop, tablet, smart phone or other similar device with appropriate application software. The control interface 491 can be used to control the on/off status of each power supply 482 based upon information from the occupancy sensor 489 or other information such as the date and/or the time. The control interface 491 can also control more than just the power supplies 482 and may be the control interface for controlling various other equipment inside the particular room in which the system 480 is located. In a conference room, for example, the control interface 491 could be used to control the lights, the shades, the projector, the projector screen, the audio, the HVAC, and the like, in addition to the shared power supplies 482 for the wireless charging transmitters 481. The control interface 491 can optionally connect to a broader building network or to the internet so that the power supplies 482 and their connected wireless charging transmitters 481 can be controlled from outside the room.

As discussed above, the wireless charging transmitters 181, 281, 381, 481 can wirelessly provide power to a charging area on the top surface of table 186, 286, 386, 486 such that suitably configured devices that are placed on the top surface of the table 186, 286, 386, 486 in the vicinity of the charging area become charged. However, without more indication, the charging area may be effectively invisible on the top surface.

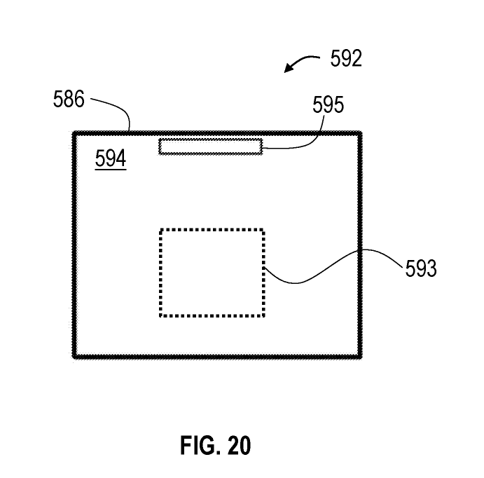

FIG. 20 shows an indication system 592 that may be incorporated into or used with the wireless charging systems 180, 280, 380, 480 to provide an indication of a charging area 593 on a top surface 594 of the table 586 powered by a wireless transmitter such as the wireless transmitters 181, 281, 381, 481. The indication system 592 includes a satellite 595. Satellite 595 may be located on the top surface 594 of the table 586 as shown. Alternatively, satellite 595 may be located elsewhere; for example, it may be mounted to a wall or the ceiling of the room. The satellite 595 is configured to project light to the top surface 594 of the conference-room table 586 to provide an indication of the location of the charging area 593. As seen in FIG. 20, the satellite 595 may have a width that essentially matches a width of the charging area 593 as an additional visual cue as to the size of the charging area 593. However, it should be readily understood that the width of the satellite 595 may be larger or smaller than the width of the charging area 593.

The exemplary satellite 595 illustrated in FIG. 20 is shown in a state of non-use and, thus, there is no indication of the charging area 593 visible on the top surface 594.

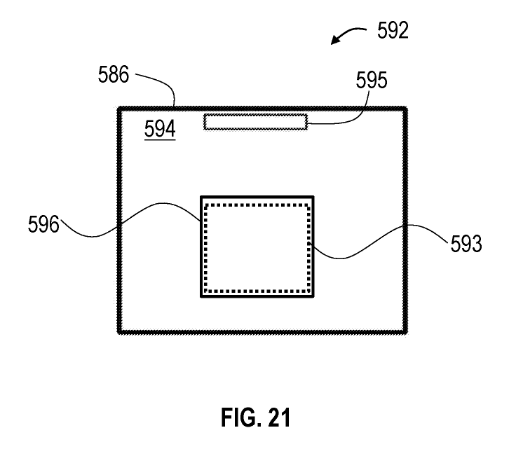

Referring to FIG. 21, the indication system 592 is shown in a state of use with the satellite 595 projecting light to form a target area pattern 596 approximating the exact size, shape, and location of the charging area 593 on the top surface 594 of the conference-room table 586. The projected pattern 596, thus, provides a visible indication of the size, shape and location of the charging area 593 to the user. Thus, the projected pattern 596 may be described as providing a complete indication of the charging area properties.

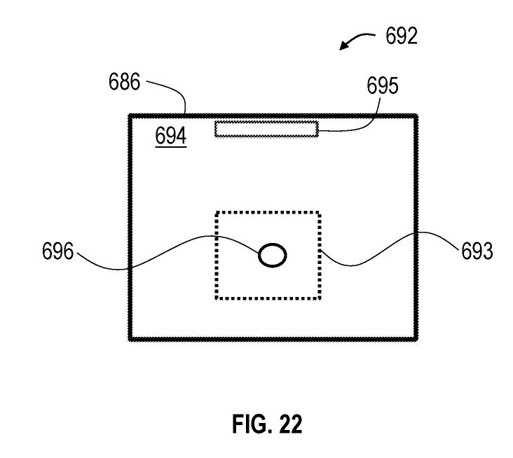

FIG. 22 shows another exemplary indication system 692 similar to the indication system 592 shown in FIGS. 20 and 21. The indication system 692 includes a satellite 695. Satellite 695 may be located on the top surface 694 of the conference-room table 686 as shown. Alternatively, satellite 695 may be located elsewhere; for example, it may be mounted to a wall or the ceiling of the room. Satellite 695 is configured to project light on the top surface 694 of the conference-room table 686. In operation, the satellite 695 projects light to form a target area pattern 696 on top surface 694 of table 686. The target area pattern 696 is smaller in size than the actual charging area 693 and may be projected at an approximate center of the charging area 693 on the conference-room table 686. While the projected pattern shown in FIG. 22 is a circle, it should be readily understood that the projected pattern may be of any shape. Additionally, the projected shape may advantageously be the same shape as the charging area 693, just smaller in size, to provide an indication of not only the location but also the size of the charging area 693. Thus, the projected pattern 696 provides a visible indication of the charging area 693 to the user. Thus, the projected pattern 696 can be described as a basic indication since it provides the location of the charging area 693 and possibly the shape, but not the size.

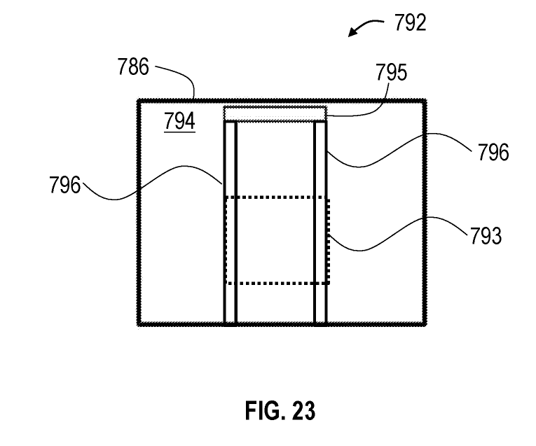

FIG. 23 shows another exemplary indication system 792 similar to the indication systems shown in FIGS. 20-22. The indication system 792 includes a satellite 795. Satellite 795 may be located on the top surface 794 of the conference-room table 786 as shown. Alternatively, satellite 795 may be located elsewhere; for example, it may be mounted to a wall or the ceiling of the room. Satellite 795 is configured to project light on the top surface 794 of the conference-room table 786. In operation, the satellite 795 projects beams of light to form a target area pattern 796 on the top surface of the conference-room table 786. The beams of light are aligned with the lateral edges of the charging area 793. Thus, the beams of light may guide the user's lateral placement of devices for charging. The target area pattern 796 in the form of projected beams of light, thus, provides a visible indication of charging area 793. The target area pattern 796 can be described as a guideline indication since it only provides some indication of the outer boundaries of the charging area 793.

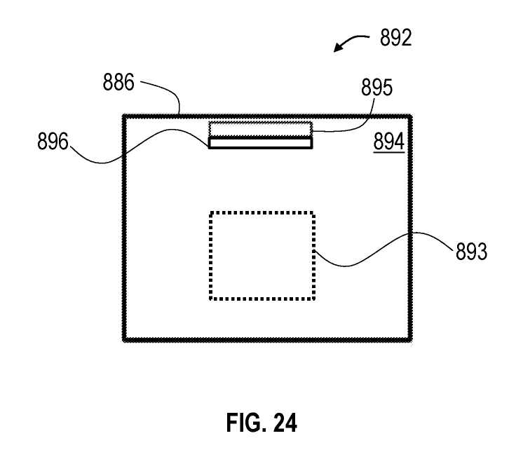

FIG. 24 shows another exemplary indication system 892 similar to the indication systems shown in FIGS. 20-23. The indication system 892 includes a satellite 895. Satellite 895 may be located on the top surface 894 of the conference-room table 886 as shown. Alternatively, satellite 895 may be located elsewhere; for example, it may be mounted to a wall or the ceiling of the room. Satellite 895 is configured to project light on the top surface 894 of the conference-room table 886. In operation, the satellite 895 projects light to form a target area pattern 896 as an edgelight indication that is a simple glow at the edge of the table 886 on the side of the satellite 895 as shown (when the satellite 895 is mounted on the top surface 894 of the conference-room table 886) or the edge of the opposite side of the table. The projected glow pattern 896 provides an indication of the charging area 893. In particular, the projected pattern 896 at the edge of the table 886 or satellite 895 provides an indication that a charging area 893 is present on the table 886 in front of the light. Alternatively, instead of satellite 895, an indicator bar may be integrated with or mounted to the side thickness of the table to indicate the approximate location of charging area 893.

While FIGS. 20-24 depict particular forms for providing visual indications for the charging areas 593, 693, 793, 893 on the top surfaces 594, 694, 794, 894 of the conference-room table 586, 686, 786, 886, it should be readily understood that the spirit and scope of the present disclosure includes other similar embodiments and is not limited to these exemplary indications. For example, indications may be provided where two or more charging areas are illuminated by one satellite. Additionally, although shown separately for simplicity, it should be readily understood that the various exemplary indication systems could be combined together and multiple indication systems could be incorporated into a single wireless charging system.

Additionally, for all of the lighting configurations, the light could vary its intensity and/or color dynamically as a device moves near the target charging area to help guide its final movement into the best placement position for optimal charging. These prompts could be in addition to, or in conjunction with, other cues such as audible or haptic indicators.

In addition to indicating the location of the charging areas 593, 693, 793, 893, the projected light may indicate the charging status of the device via variations in color, intensity, pattern, etc. For example, it could initially be white in the absence of a device to be charged, change to green to indicate that a charging state had been achieved, and then to blue to indicate a full battery condition. Additionally, the light may include a single source or be made up of multiple coordinated sources in order to best fulfill its intended functions.

The satellites 595, 695, 795, 895 may be combined with sensors such as the occupancy sensors 389, shown in FIG. 18, to modify its operation in the presence of a user, for example to turn on when a user approaches or to turn off when no one is present.

The wireless charging system 180 may advantageously provide various charging areas on a table surface—either for the convenience of the user, or to accommodate multiple devices simultaneously in different locations—without requiring multiple transmitters that each have their own power supply and attendant power cord installed in an array across the lower surface of the table.

The present disclosure advantageously provides an organized wireless charging system for a large surface, such as a conference-room table or the like, that avoids the clutter associated with using multiple independent charging transmitters that have their own power supplies.

The present disclosure also advantageously provides visible indications where otherwise invisible charging areas of the wireless charging systems are located because, although an under table wireless power transmitter can provide a user a way to charge their device on the table without any unsightly or encumbering characteristics of typical charging cords or docks, the very nature of the installation can make the effective charging, or target, area of the table—where the user must place their device to effectively charge—invisible. The visible indications may be in the form of light configured to provide a distinct lighted pattern that may correspond exactly to the target charging area. Alternatively, it could indicate the target area via a subtle glow in the approximate location, such as a spot indicator in the center of the charge area, guiding columns of light at either edge of the area, or simply a light near the edge of the table indicating the presence and approximate lateral location of a charging area. The illuminated indicators of the present disclosure provide advantages over using physical features (e.g. mats, ridges, raised or depressed areas, differing finishes, etc.) including labels or icons, which can ruin the clean aesthetic of the installation.

Various modifications to the specific examples described in this disclosure and depicted in the drawings will be apparent to a person having ordinary skill in the art. For example, the wireless charging transmitters discussed above may use magnetic-resonance-based wireless charging technology, which is best suited to through-surface operation. However, the systems of the present disclosure can alternatively employ wireless charging transmitters that use inductive wireless-charging technology. For example, the wireless charging systems can employ wireless charging transmitters that are compliant with the Wireless Power Consortium's Qi standard or the Power Matters Alliance's PMA standard. As should be understood by those skilled in the art, the distance over which power can be transmitted wirelessly is much smaller for inductive technologies than for magnetic resonance technologies and, therefore, the wireless charging transmitters would need to be mounted directly to the top of the surface instead of the underside or would need to be embedded just below the top of the surface.

While various embodiments have been illustrated and described, it will be appreciated by those of ordinary skill in the art that modifications can be made to the various embodiments without departing from the spirit and scope of the invention as a whole.

What is claimed is:

1. A wireless, portable charger tray comprising:
an internal rechargeable power supply;
a first wireless power transmitter connected to the internal rechargeable power supply; and
a case housing the internal rechargeable power supply and the wireless power transmitter;
wherein the wireless power transmitter is configured to wirelessly transmit a first charging power to one or more electronic devices.

2. The portable charger tray of claim 1, further comprising a charging receiver connected to the internal rechargeable power supply;
wherein the charging receiver is configured to be operatively coupled to an external power supply for transmission of a second charging power for recharging the internal rechargeable power supply.

3. The portable charger tray of claim 2, wherein the charging receiver comprises a wireless power receiver configured to wirelessly connect to a second wireless power transmitter of the external power supply for wireless transmission of the second charging power for recharging the internal rechargeable power supply.

4. The portable charger tray of claim 3, further comprising a coil housed in the case, the coil acting as a passive resonant repeater to transfer power from a transmitting antenna of the second wireless power transmitter of the external power supply to a receiving antenna of the one or more electronic devices.

5. The portable charger tray of claim 1, further comprising a visual indicator for indicating a charge level of the internal rechargeable power supply, a charging status of the internal rechargeable power supply and/or a successful charging link to the one or more electronic devices.

6. The portable charger tray of claim 1, further comprising at least one power jack operatively connected to the internal rechargeable power supply for supplying power.

7. The portable charger tray of claim 6, wherein the at least one power jack is a USB socket.

8. A wireless charging station comprising:
a bowl-shaped body including a bottom portion and a sidewall extending upwardly from the bottom portion; and
a wireless power transmitter disposed within the bottom portion and connected to a power supply;
wherein the wireless power transmitter is configured to transmit a wireless charging field upwardly from the bottom portion.

9. The wireless charging station according to claim 8, wherein the bottom portion includes a substantially flat lower surface.

10. The wireless charging station according to claim 8, wherein the sidewall has an inverted frusto-conical shape.

11. The wireless charging station according to claim 8, wherein the wireless power transmitter is configured to transmit the wireless charging field upwardly from the bottom portion to a top of the sidewall.

12. The wireless charging station according to claim 8, wherein the power supply includes a rechargeable battery configured to supply power to the wireless power transmitter.

13. The wireless charging station according to claim 8, additionally comprising at least one USB port disposed on an exterior of the bowl-shaped body and operatively connected to the power supply.

14. A wireless charging system comprising:
a power supply;
a plurality of wireless charging transmitters adapted to be mounted on an underside of a surface; and
a power distribution system adapted to connect the plurality of wireless charging transmitters to the power supply;
wherein the plurality of wireless charging transmitters are configured to generate charging areas on a top side of the surface.

15. The wireless charging system of claim 14, wherein a total combined power rating of the plurality of wireless charging transmitters is greater than the capacity of the power supply.

16. The wireless charging system of claim 14, further comprising:
a satellite configured to be mounted on the top side of the surface and to provide an indication of a charging area on the top side of the surface.

17. The wireless charging system of claim 16, wherein the satellite is configured to project light to the top side of the surface at or near at least a portion of the charging area.

18. The wireless charging system of claim 16, wherein the satellite is configured to vary at least one of the intensity or color of the projected light based on a location of a device relative to the charging area.

19. The wireless charging system of claim 14, further comprising an occupancy sensor configured to detect at least one of the presence or absence of a user in the vicinity of the occupancy sensor, wherein the occupancy sensor is configured to send a signal to the power supply to power on or off the connected wireless charging transmitters based on the detected presence or absence of the user.

20. The wireless charging system of claim 19, wherein at least one of the power supply or the occupancy sensor comprises a wireless transceiver configured to communicate with at least one of a wireless network or a communication interface.
